(19) United States
(12) Patent Application Publication
(10) Pub. No.: US 2026/0009473 A1
(43) Pub. Date: Jan. 8, 2026

(54) FLUID VALVE

(71) Applicant: Hanon Systems, Daejeon (KR)

(72) Inventors: Ho Sung KANG, Daejeon (KR); Sae Won OH, Daejeon (KR); Sang Hyun LEE, Daejeon (KR); Moon-Seok CHOI, Daejeon (KR); Jeong Wan HAN, Daejeon (KR)

(21) Appl. No.: 18/865,465

(22) PCT Filed: Jul. 3, 2023
(86) PCT No.: PCT/KR2023/009284

§ 371 Date: Nov. 13, 2024

(30) Foreign Application Priority Data
Aug. 2, 2022 (KR) 10-2022-0095940

(51) Int. Cl. F16K 11/085

(52) U.S. Cl. CPC F16K 11/0853

(57) ABSTRACT

The present invention relates to a fluid valve for a vehicle, in which a plurality of flow paths may be formed in a flow path switching housing without being placed in different layers, and a plurality of ports may be allowed to communicate with one another by a rotation of the flow path switching housing so that a fluid may flow through several branches.

### CROSS REFERENCE TO RELATED APPLICATIONS

This patent application is a national phase under 35 U.S.C. § 371 of International Patent Application No. PCT/KR2023/009284 filed Jul. 3, 2023, which claims the benefit of priority from Korean Patent Application No. 10-2022-0095940 filed Aug. 2, 2022, each of which is hereby incorporated herein by reference in its entirety for all purposes

### TECHNICAL FIELD

The present invention relates to a fluid valve for a vehicle.

### BACKGROUND ART

Recently, there has been a significant increase in demand for electric vehicles as environmentally-friendly vehicles that do not cause air pollution.

In general, even in a vehicle using an internal combustion engine, a valve is used to control a flow of a coolant to cool an engine or the like. Because the electric vehicle uses electrical energy of a mounted battery pack, it is important to maintain a temperature of a battery, which is sensitive to the temperature, within a predetermined range.

In particular, because a charging capacity or a discharging capacity of the battery is rapidly decreased at a particular temperature or lower or a particular temperature or higher, the temperature of the battery pack mounted in the electric vehicle always needs to be maintained in a predetermined temperature range.

A method of adjusting the temperature of the battery pack by using a coolant is mainly used. In case that the coolant is used to adjust the temperature of the battery pack as described above, a coolant valve is essentially used to change a flow direction of the coolant depending on an operating condition of the vehicle.

FIG. 1 is a view schematically illustrating a coolant valve in the related art. A branch pipe 20 is provided in a valve housing 10 provided in the form of a cylindrical pipe elongated in a longitudinal direction to change flow paths for a coolant, and the branch pipe 20 has therein a plurality of communication flow paths 21 provided at different heights.

In case that the heights of the communication flow paths 21 of the branch pipe 20 are different so that the flow paths for the coolant are changed without overlapping one another in the valve housing 10, there is a problem in that a size of the coolant valve increases.

In addition, a sealing member 30 is inserted between the communication flow paths 21 of the branch pipe 20 and the inside of the valve housing 10 to prevent a leak of the coolant. However, there is a problem in that the valve housing 10 is increased in size, and an area of the sealing member 30 is increased by the communication flow paths 21 provided at different heights.

As a related document, there is Korean Patent No. 10-2179242 (Nov. 16, 2020).

### DISCLOSURE

### Technical Problem

An object of the present invention is to provide a fluid valve in which a plurality of ports are allowed to communicate with one another by a rotation of a flow path switching housing in a main body housing, such that a fluid, such as a coolant, may flow through several branches.

### Technical Solution

The present invention provides a fluid valve including: a main body housing having an outer peripheral surface in which a plurality of ports are formed on the same line in a height direction; and a flow path switching housing having an outer peripheral surface in which a plurality of communication holes are formed on the same line in the height direction, the flow path switching housing having therein a plurality of flow paths divided by separation walls so that the plurality of communication holes are selectively connected, and the flow path switching housing being rotatably provided in the main body housing and configured to rotate about a center of the main body housing, in which the plurality of ports are allowed to selectively communicate with one another by a rotation of the flow path switching housing, such that a flow path of a fluid is changed.

In addition, the plurality of ports may be formed at preset intervals based on a central axis of the main body housing.

In addition, the plurality of communication holes may be formed at preset intervals based on a central axis of the flow path switching housing.

In addition, the plurality of flow paths may be divided into a first group and a second group by the separation wall, and the first group or the second group may be selected as the flow path, through which the fluid flows, by the rotation of the flow path switching housing.

In addition, when the first group or the second group is selected, the plurality of ports may communicate with one another two by two so that the fluid flows.

In addition, the plurality of ports may be formed at preset intervals radially based on the central axis of the main body housing.

In addition, the plurality of communication holes may be formed at preset intervals radially based on the central axis of the flow path switching housing.

In addition, a sealing member may be provided on an inner peripheral surface of the main body housing at positions at which the plurality of ports are formed, and the sealing member may prevent the fluid from leaking.

In addition, the fluid valve may further include: a drive part disposed above or below the main body housing, connected to the flow path switching housing, and configured to rotate the flow path switching housing.

In addition, first to twelfth communication holes may be formed around an outer peripheral surface of the flow path switching housing, and flow paths, which are made by connecting two pairs of communication holes among the first to twelfth communication holes, may be formed in the flow path switching housing.

In addition, in the flow path switching housing, a first flow path, which connects the first communication hole and the third communication hole, may be formed, a second flow path, which connects the fifth communication hole and the ninth communication hole, may be formed, a third flow path, which connects the seventh communication hole and the eleventh communication hole, may be formed, a fourth flow path, which connects the second communication hole and the twelfth communication hole, may be formed, a fifth flow path, which connects the fourth communication hole and the sixth communication hole, may be formed, and a sixth flow path, which connects the eighth communication hole and the tenth communication hole, may be formed.

In addition, in the flow path switching housing, the first to third flow paths may constitute a first group, and the fourth to sixth flow paths may constitute a second group. When the first or second group is selected by a rotation of the flow path switching housing, the fluid may be allowed to flow by the selected first or second group.

In addition, the first to sixth ports are connected two by two by the flow paths made by the selected group when the first or second group is selected, and the first to sixth ports are connected two by two when the first or second group is selected, such that the fluid flows.

In addition, the first to third flow paths and the fourth to sixth flow paths, which are formed by connecting the communication holes, are divided into the first group and the second group and formed at the same position in a height direction of the flow path switching housing, such that the first group and the second group are formed such that the flow paths are separated in the same height.

In addition, in the flow path switching housing, the first flow path and the second flow path may be formed on the same plane while penetrating an interior of the flow path switching housing, and the third flow path may be formed to penetrate the flow path switching housing while bypassing the first flow path and the second flow path in a vertical direction.

In addition, the fourth to sixth flow paths may be separated by separation walls formed in the flow path switching housing.

In addition, the first flow path and the second flow path may be formed to traverse partial spaces in the fourth to sixth flow paths.

In addition, when the flow path switching housing rotates clockwise, the first group and the second group are alternately selected and allow the first to sixth ports to communicate with one another two by two.

### Advantageous Effects

According to the present invention, the plurality of flow paths may be formed in the flow path switching housing without being placed in different layers, and the plurality of ports may be allowed to communicate with one another by the rotation of the flow path switching housing so that the fluid may flow through several branches.

### BRIEF DESCRIPTION OF THE DRAWINGS

FIG. 1 is a configuration view illustrating a fluid valve in the related art.

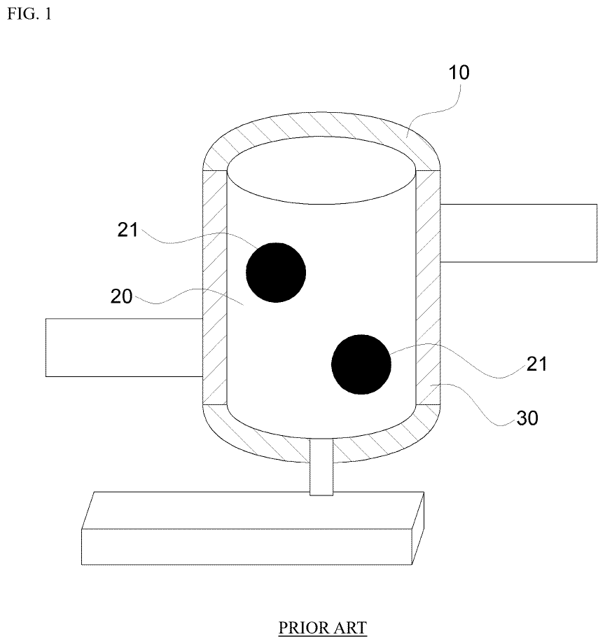

FIG. 2 is a perspective view illustrating a fluid valve according to an embodiment of the present invention.

FIG. 3 is a cross-sectional view illustrating the fluid valve according to the embodiment of the present invention.

FIG. 4 is a view illustrating a flow path switching housing of the fluid valve according to the embodiment of the present invention.

FIG. 5 is a cross-sectional view of the fluid valve according to the embodiment of the present invention.

FIG. 6 is a cross-sectional view illustrating the fluid valve according to the embodiment of the present invention.

FIG. 7 is a view illustrating a state in which flow paths in the flow path switching housing of the fluid valve according to the embodiment of the present invention are selected.

FIG. 8 is a view illustrating a state in which flow paths different from the flow paths in FIG. 7 are selected.

Description of Reference Numerals

| | |
|---|---|
| 100: Main body housing | |
| 110: First port | 120: Second port |
| 130: Third port | 140: Fourth port |
| 150: Fifth port | 160: Sixth port |
| 170: Sealing member | |
| 200: Flow path switching housing | |
| 210: Communication hole | |
| 210a: First communication hole | 210b: Second communication hole |
| 210c: Third communication hole | 210d: Fourth communication hole |
| 210e: Fifth communication hole | 210f: Sixth communication hole |
| 210g: Seventh communication hole | 210h: Eighth communication hole |
| 210k: Ninth communication hole | 210m: Tenth communication hole |
| 210n: Eleventh communication hole | 210p: Twelfth communication hole |
| 220: First group | |
| 221: First flow path | 222: Second flow path |
| 223: Third flow path | 230: Second group |
| 231: Fourth flow path | 232: Fifth flow path |
| 233: Sixth flow path | |
| 240: Connection part | |
| 300: Drive part | |

### MODE FOR INVENTION

Exemplary embodiments of the present invention will be described with reference to the accompanying drawings to sufficiently understand the present invention. The embodiments of the present invention may be modified in various different forms, and it is not interpreted that the scope of the present invention is limited to the following embodiments described below in detail. The present embodiments are provided to more fully explain the present invention to those skilled in the art. Therefore, shapes and the like of elements in the drawings may be exaggerated to emphasize a clearer explanation. It should be noted that the same members are sometimes denoted by the same reference numerals in each drawing. In addition, descriptions of publicly known related functions or configurations will be omitted when it is determined that the specific descriptions may unnecessarily obscure the subject matter of the present invention.

Hereinafter, embodiments of the present invention will be described with reference to the accompanying drawings.

A fluid valve according to the embodiment of the present invention may include a main body housing 100, and a flow path switching housing 200 provided in the main body housing 100.

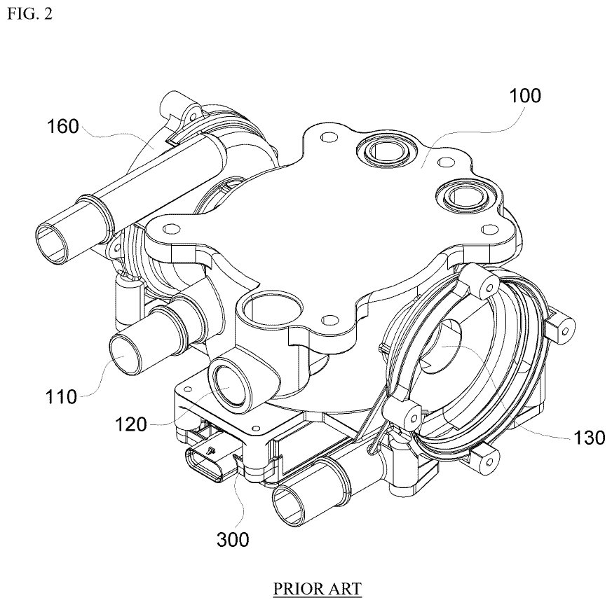

With reference to FIGS. 2 to 4, the main body housing 100 has a plurality of ports formed on the same line in an outer peripheral surface thereof in a height direction. The ports, which each have an inlet and an outlet through which a fluid flows, may be formed in the outer peripheral surface of the main body housing 100 and provided at the same position in the height direction.

The flow path switching housing 200 has a plurality of communication holes 210 formed on the same line in an outer peripheral surface thereof in the height direction. The flow path switching housing 200 has therein a plurality of flow paths separated by separation walls 250 so that the plurality of communication holes 210 are selectively connected. The flow path switching housing 200 is rotatably provided in the main body housing 100 and configured to rotate about a center of the main body housing 100.

First to sixth ports 110, 120, 130, 140, 150, and 160 are formed in the outer peripheral surface of the main body housing 100. The plurality of communication holes 210 are formed in the outer peripheral surface of the flow path switching housing 200, and the plurality of communication holes 210 are connected in the flow path switching housing 200 and define the plurality of flow paths. Among the plurality of communication holes 210, two communication holes are connected and define a flow path of the plurality of flow paths in the flow path switching housing 200.

The flow path switching housing 200 is rotatably provided in the main body housing 100. The flow path switching housing 200 rotates about the center of the main body housing 100 to change the flow path through which the fluid flows and allows the first to sixth ports 110, 120, 130, 140, 150, and 160 to selectively communicate with one another.

A drive part 300 may be disposed above or below the main body housing 100 and rotate the flow path switching housing 200. The drive part 300 is connected to the flow path switching housing 200 and rotates the flow path switching housing 200 by a preset angle. A connection part 240 is provided on a central portion of the flow path switching housing 200 and protrudes upward or downward from the main body housing 100. A rotational force of the drive part 300 is transmitted to the flow path switching housing 200 by the connection part 240.

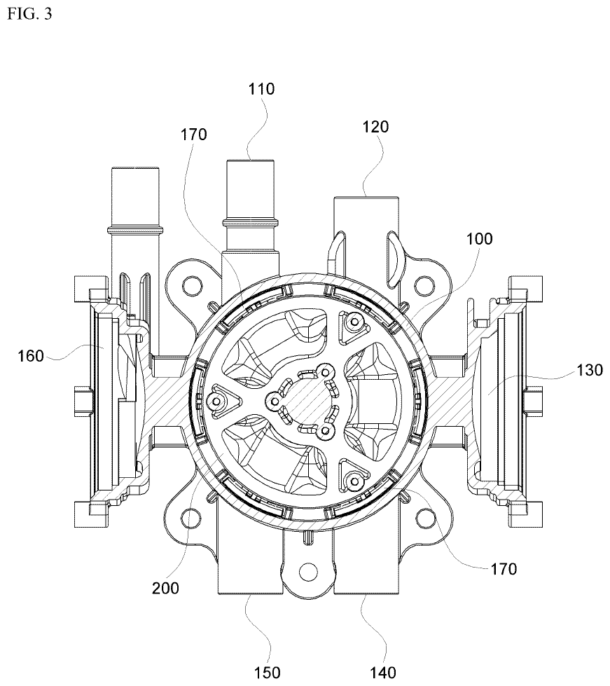

With reference back to FIG. 3, the first to sixth ports 110, 120, 130, 140, 150, and 160 may be provided at preset intervals based on a central axis of the main body housing 100. Further, the first to sixth ports 110, 120, 130, 140, 150, and 160 may be provided at intervals of 60° radially based on the central axis of the main body housing 100.

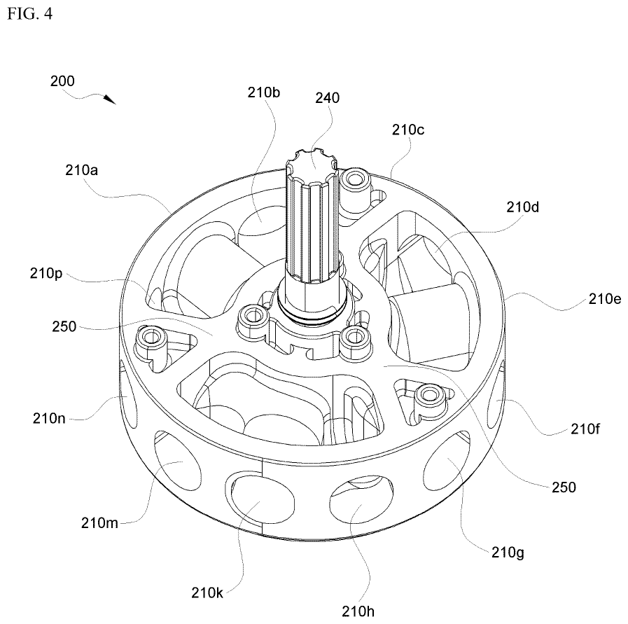

With reference back to FIG. 4, the plurality of communication holes 210 may include first to twelfth communication holes 210a, 210b, 210c, 210d, 210e, 210f, 210g, 210h, 210k, 210m, 210n, and 210p provided at preset intervals based on a central axis of the flow path switching housing 200.

The first to twelfth communication holes 210a, 210b, 210c, 210d, 210e, 210f, 210g, 210h, 210k, 210m, 210n, and 210p are provided around the outer peripheral surface of the flow path switching housing 200. Flow paths, which are made by connecting two pairs of communication holes among the first to twelfth communication holes 210a, 210b, 210c, 210d, 210e, 210f, 210g, 210h, 210k, 210m, 210n, and 210p, are formed in the flow path switching housing 200.

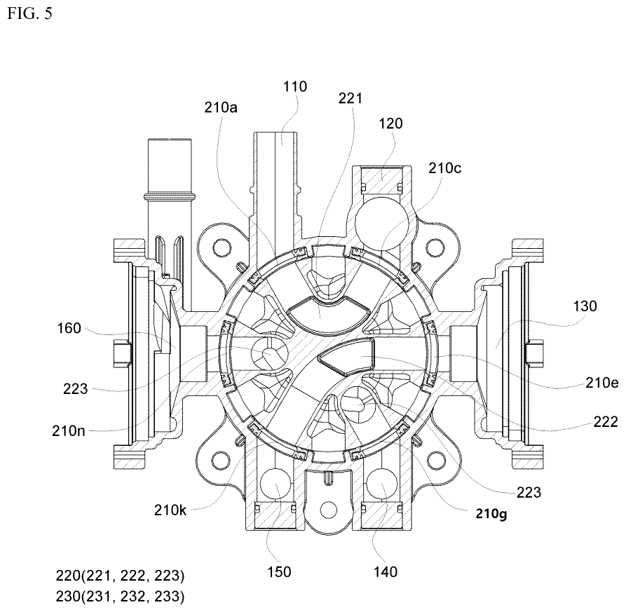

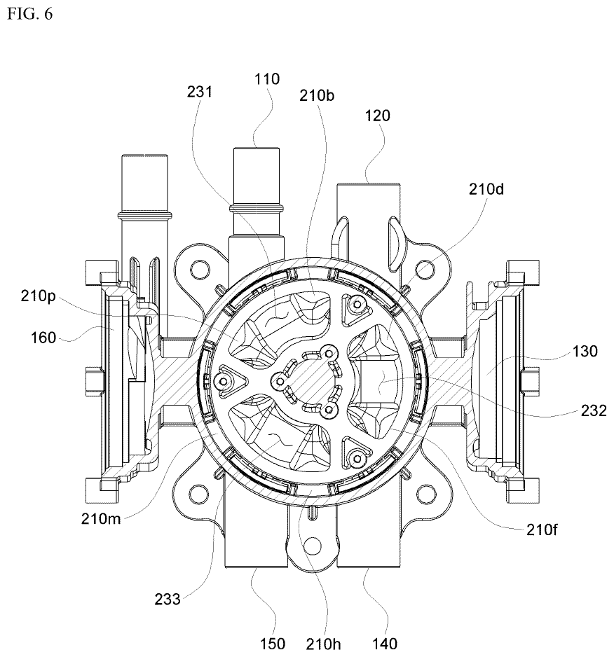

With reference to FIG. 5, in the flow path switching housing 200, a first flow path 221, which connects the first communication hole 210a and the third communication hole 210c, is formed, a second flow path 222, which connects the fifth communication hole 210e and the ninth communication hole 210k, is formed, and a third flow path 223, which connects the seventh communication hole 210g and the eleventh communication hole 210n, is formed. With reference to FIG. 6, a fourth flow path 231, which connects the second communication hole 210b and the twelfth communication hole 210p, is formed, a fifth flow path 232, which connects the fourth communication hole 210d and the sixth communication hole 210f, is formed, and a sixth flow path 233, which connects the eighth communication hole 210h and the tenth communication hole 210m, is formed.

In the flow path switching housing 200, the first to third flow paths 221, 222, and 223 constitute a first group 220, and the fourth to sixth flow paths 231, 232, and 233 constitute a second group 230. The first group 220 or the second group 230 is selected by the rotation of the flow path switching housing 200, and the fluid flows to the selected first group 220 or the selected second group 230.

When the first group 220 or the second group 230, which includes the flow paths through which the fluid will flow in the flow path switching housing 200, is selected by the rotation of the flow path switching housing 200, the first to sixth ports 110, 120, 130, 140, 150, and 160 are connected two by two by the flow paths formed by the selected group.

When the first group 220 or the second group 230 is selected, the first to sixth ports 110, 120, 130, 140, 150, and 160 communicate with one another two by two, such that the fluid flows through the first to sixth ports 110, 120, 130, 140, 150, and 160.

The first to third flow paths 221, 222, and 223 and the fourth to sixth flow paths 231, 232, and 233, which are formed by connecting the communication holes 210 are divided into the first group 220 and the second group 230 and formed at the same position in the height direction of the flow path switching housing 200.

The first group 220 and the second group 230 are formed so that the flow paths are separated at the same heights without being formed in layers separated at different positions in the height direction.

The first communication hole 210a and the third communication hole 210c are formed at an interval of 60° in the first flow path 221, the fifth communication hole 210e and the ninth the communication hole 210k are formed at an interval of 120° in the second flow path 222, and the seventh the communication hole 210g and the eleventh the communication hole 210n are formed at an interval of 120° in the third flow path 223.

The communication holes are formed at an interval of 60° in the fourth to sixth flow paths 231, 232, and 233. The second communication hole 210b and the twelfth the communication hole 210p are formed at an interval of 60° in the fourth flow path 231, the fourth communication hole 210d and the sixth the communication hole 210f are formed at an interval of 60° in the fifth flow path 232, and the eighth the communication hole 210h and the tenth the communication hole 210m are formed at an interval of 60° in the sixth flow path 233.

To this end, the first to twelfth communication holes 210a, 210b, 210c, 210d, 210e, 210f, 210g, 210h, 210k, 210m, 210n, and 210p are formed at intervals of 30° radially based on the central axis of the flow path switching housing 200. The first to twelfth communication holes 210a, 210b, 210c, 210d, 210e, 210f, 210g, 210h, 210k, 210m, 210n, and 210p are formed at intervals of 30° sequentially in the outer peripheral surface of the flow path switching housing 200.

In the flow path switching housing 200, the first flow path 221 and the second flow path 222 are formed on the same plane while penetrating the interior of the flow path switching housing 200, and the third flow path 223 is formed to penetrate the flow path switching housing 200 while bypassing the first flow path 221 and the second flow path 222 in the vertical direction.

The fourth to sixth flow paths 231, 232, and 233 may be separated by the separation walls 250 formed in the flow path switching housing 200. With reference back to FIG. 4, the three separation walls 250 may be equally divided the internal space of the flow path switching housing 200, and the divided three spaces may define the fourth to sixth flow paths 231, 232, and 233.

In this case, the first flow path 221 and the second flow path 222 may be formed to traverse partial spaces in the fourth to sixth flow paths 231, 232, and 233.

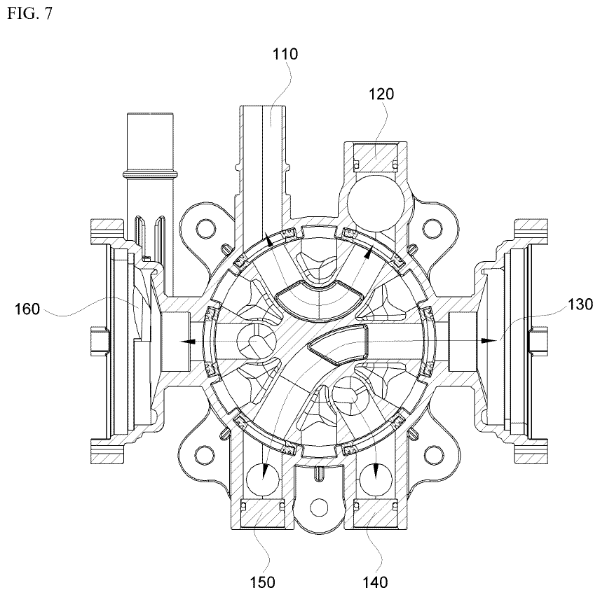

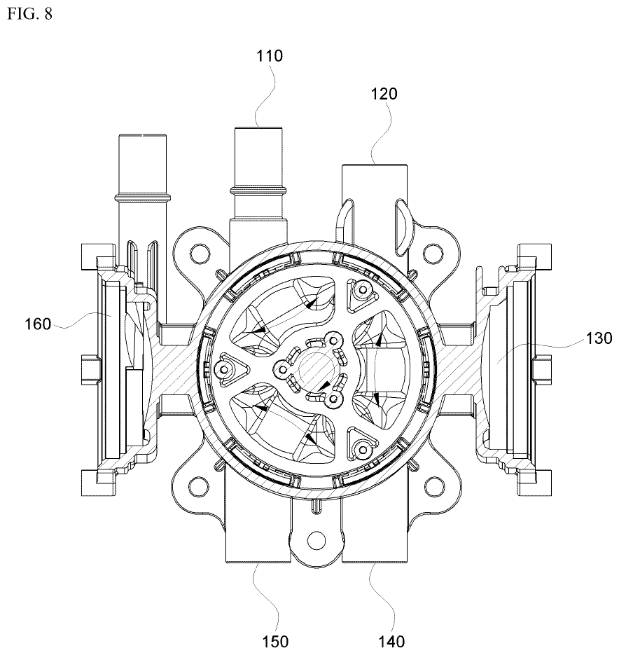

A configuration in which the first to sixth ports 110, 120, 130, 140, 150, and 160 communicate with one another as the flow path switching housing 200 rotates will be described with reference to FIGS. 7 and 8.

Assuming that a mode in which the fluid branches and flows through the position of the flow path switching housing 200 illustrated in FIG. 7 is a first mode, the first group 220 is selected in the first mode. The first port 110 and the second port 120 are allowed to communicate with each other by the first flow path 221, the third port 130 and the fifth port 150 are allowed to communicate with each other by the second flow path 222, and the fourth port 140 and the sixth port 160 are allowed to communicate with each other by the third flow path 223. In this case, in the fourth to sixth flow paths 231, 232, and 233 of the remaining second group 230, the second, fourth, sixth, eighth, tenth, and twelfth communication holes 210b, 210d, 210h, 210g, 210m, and 210p, which connect the fourth to sixth flow paths 231, 232, and 233, are blocked by the inner peripheral surface of the main body housing 100.

Next, when the flow path switching housing 200 rotates by 30° clockwise, the second group 230 is selected in the flow path switching housing 200. Then, the first port 110 and the second port 120 are allowed to communicate with each other by the fourth flow path 231, the third port 130 and the fourth port 140 are allowed to communicate with each other by the fifth flow path 232, and the fifth port 150 and the sixth port 160 are allowed to communicate with each other by the sixth flow path 233. This mode may be defined as a second mode. In this case, in the first to third flow paths 221, 222, and 223 of the remaining first group 220, the first, third, fifth, seventh, ninth, and eleventh communication holes 210a, 210c, 210e, 210g, 210k, and 210p, which connect the first to third flow paths 221, 222, and 223, are blocked by the inner peripheral surface of the main body housing 100.

Next, when the flow path switching housing 200 rotates by 30° clockwise, the first group 220 is selected again in the flow path switching housing 200, and the first to sixth ports 110, 120, 130, 140, 150, and 160 are selected and communicate with one another two by two.

In this way, as the flow path switching housing 200 rotates by 30° clockwise, the first group 220 and the second group 230 are alternately selected and allow the first to sixth ports 110, 120, 130, 140, 150, and 160 to communicate with one another two by two.

Only the first mode and the second mode have been described above, but a total of eleven modes may be implemented as the flow path switching housing 200 rotates by 30° clockwise. In this case, the modes have been described on the assumption that the rotation direction is the clockwise direction. However, a rotation in the counterclockwise may also be set.

As described above, the plurality of ports are allowed to communicate with one another by the rotation of the flow path switching housing, such that the fluid may flow through several branches.

With reference back to FIG. 3, sealing members 170 are provided on the inner peripheral surface of the main body housing 100 and prevent a leak of the fluid at the positions at which the plurality of ports are formed.

The sealing members 170 are provided on the inner peripheral surface of the main body housing 100 at the positions at which the first to sixth ports 110, 120, 130, 140, 150, and 160 are formed. The flow path switching housing 200 is provided in the main body housing 100, and the sealing member 170 is disposed between the inner peripheral surface of the main body housing 100 and the outer peripheral surface of the flow path switching housing 200.

The sealing members 170 prevent the fluid from leaking to the outside of the flow path switching housing 200 when the communication holes 210 and the first to sixth ports 110, 120, 130, 140, 150, and 160 communicate with one another. Further, the communication holes 210 are positioned on the same line in the circumferential direction in the outer peripheral surface of the flow path switching housing 200. Therefore, the sealing members 170 only need to be provided at the positions corresponding to the first to sixth ports 110, 120, 130, 140, 150, and 160 without being provided to correspond to all the communication holes 210. Therefore, a size of the sealing member 170 to be used is reduced. This may reduce the amount of torque made by the drive part 300 when the flow path switching housing 200 rotates.

The above-mentioned embodiments of the present invention are for illustrative purposes only, and those skilled in the art to which the present technology pertains will understand that various modifications of the embodiments and other embodiments equivalent thereto are available. Therefore, it will be well understood that the present invention is not limited to the forms mentioned in the detailed description. Accordingly, the true technical protection scope of the present invention should be determined by the technical spirit of the appended claims. In addition, it should be understood that the present invention includes all modifications, equivalents, and substitutes within the spirit and scope of the present invention defined by the appended claims.

1. A fluid valve comprising:
a main body housing having an outer peripheral surface in which a plurality of ports are formed on the same line in a height direction; and
a flow path switching housing having an outer peripheral surface in which a plurality of communication holes are formed on the same line in the height direction, the flow path switching housing having therein a plurality of flow paths divided by separation walls so that the plurality of communication holes are selectively connected, and the flow path switching housing being rotatably provided in the main body housing and configured to rotate about a center of the main body housing,
wherein the plurality of ports are allowed to selectively communicate with one another by a rotation of the flow path switching housing, such that a flow path of a fluid is changed.

2. The fluid valve of claim 1, wherein the plurality of ports are formed at preset intervals based on a central axis of the main body housing.

3. The fluid valve of claim 1, wherein the plurality of communication holes are formed at preset intervals based on a central axis of the flow path switching housing.

4. The fluid valve of claim 3, wherein the plurality of flow paths are divided into a first group and a second group by the separation wall, and the first group or the second group is selected as the flow path, through which the fluid flows, by the rotation of the flow path switching housing.

5. The fluid valve of claim 4, wherein when the first group or the second group is selected, the plurality of ports communicate with one another two by two so that the fluid flows.

6. The fluid valve of claim 2, wherein the plurality of ports are formed at preset intervals radially based on the central axis of the main body housing.

7. The fluid valve of claim 3, wherein the plurality of communication holes are formed at preset intervals radially based on the central axis of the flow path switching housing.

8. The fluid valve of claim 1, wherein a sealing member is provided on an inner peripheral surface of the main body housing at positions at which the plurality of ports are formed, and the sealing member prevents the fluid from leaking.

9. The fluid valve of claim 1, further comprising:
a drive part disposed above or below the main body housing, connected to the flow path switching housing, and configured to rotate the flow path switching housing.

10. The fluid valve of claim 5, wherein first to twelfth communication holes are formed around an outer peripheral surface of the flow path switching housing, and flow paths, which are made by connecting two pairs of communication holes among the first to twelfth communication holes, are formed in the flow path switching housing.

11. The fluid valve of claim 10, wherein in the flow path switching housing, a first flow path, which connects the first communication hole and the third communication hole, is formed, a second flow path, which connects the fifth communication hole and the ninth communication hole, is formed, a third flow path, which connects the seventh communication hole and the eleventh communication hole, is formed, a fourth flow path, which connects the second communication hole and the twelfth communication hole, is formed, a fifth flow path, which connects the fourth communication hole and the sixth communication hole, is formed, and a sixth flow path, which connects the eighth communication hole and the tenth communication hole, is formed.

12. The fluid valve of claim 11, wherein in the flow path switching housing, the first to third flow paths constitute a first group, and the fourth to sixth flow paths constitute a second group.

13. The fluid valve of claim 12, wherein when the first or second group is selected by a rotation of the flow path switching housing, the fluid is allowed to flow by the selected first or second group.

14. The fluid valve of claim 13, wherein the first to sixth ports are connected two by two by the flow paths made by the selected group when the first or second group is selected, and the first to sixth ports are connected two by two when the first or second group is selected, such that the fluid flows.

15. The fluid valve of claim 12, wherein the first to third flow paths and the fourth to sixth flow paths, which are formed by connecting the communication holes, are divided into the first group and the second group and formed at the same position in a height direction of the flow path switching housing, such that the first group and the second group are formed such that the flow paths are separated in the same height.

16. The fluid valve of claim 12, wherein in the flow path switching housing, the first flow path and the second flow path are formed on the same plane while penetrating an interior of the flow path switching housing, and the third flow path is formed to penetrate the flow path switching housing while bypassing the first flow path and the second flow path in a vertical direction.

17. The fluid valve of claim 12, wherein the fourth to sixth flow paths are separated by separation walls formed in the flow path switching housing.

18. The fluid valve of claim 12, wherein the first flow path and the second flow path are formed to traverse partial spaces in the fourth to sixth flow paths.

19. The fluid valve of claim 13, wherein when the flow path switching housing rotates clockwise, the first group and the second group are alternately selected and allow the first to sixth ports to communicate with one another two by two.
